(19) United States
(12) Patent Application Publication
(10) Pub. No.: US 2023/0259417 A1
(43) Pub. Date: Aug. 17, 2023

(54) PROCESSING CIRCUIT

(71) Applicant: FUJI ELECTRIC CO., LTD., Kawasaki-shi (JP)

(72) Inventor: Kazuhiro MATSUNAMI, Matsumoto-city (JP)

(21) Appl. No.: 18/069,222

(22) Filed: Dec. 20, 2022

(30) Foreign Application Priority Data
Feb. 15, 2022 (JP) 2022-021221

(51) Int. Cl. G06F 11/07

(52) U.S. Cl. CPC G06F 11/0763; G06F 11/073

(57) ABSTRACT

Provided is a processing circuit for data of multiple bits including a first bit, a second bit, and a third bit, the processing circuit including a memory unit for storing a bit value of each bit, a first memory code, and a second memory code, a code generation unit for generating a first generation code indicating whether bit values of the first bit and the second bit stored by the memory unit are identical, and a second generation code indicating whether bit values of the second bit stored and the third bit stored by the memory unit are identical, and a determination unit for determining whether, based on a comparison result of between the first memory code and the first generation code and a comparison result between the second memory code and the second generation code, an error has occurred in the bit value of the second bit.

The contents of the following Japanese patent application(s) are incorporated herein by reference:

NO. 2022-021221 filed in JP on Feb. 15, 2022

### BACKGROUND

### 1. TECHNICAL FIELD

The present invention relates to a processing circuit.

### 2. RELATED ART

Up to now, a technique for improving tolerance to external noise of data stored in a non-volatile memory such as an EPROM in a semiconductor apparatus has been proposed (for example, see Patent documents 1 to 3).
Patent Document 1: Japanese Patent Application Publication No. H6-274421
Patent Document 2: Japanese Patent No. 6565402
Patent Document 3: Japanese Patent Application Publication No. 2015-201645

### BRIEF DESCRIPTION OF THE DRAWINGS

FIG. 1 is a block diagram illustrating an example of a sensor apparatus 100 according to an embodiment of the present invention.

FIG. 2 illustrates a configuration of a processing circuit 20 according to a comparative example.

FIG. 3 is a table summarizing whether a compensation can be performed for each of modes of the processing circuit 20 according to the comparative example of FIG. 2.

FIG. 4 illustrates a configuration the processing circuit 20 according to another comparative example.

FIG. 5 is a table summarizing whether the compensation can be performed for each of the modes of the processing circuit 20 according to the comparative example of FIG. 4.

FIG. 6 illustrates a configuration of the processing circuit 20 according to an embodiment.

FIG. 7 is a table summarizing whether the compensation can be performed for each of the modes of the processing circuit 20 according to the embodiment of FIG. 6.

FIG. 8 illustrates an example of a wiring of an element 82 included in a memory unit 52.

FIG. 9 illustrates a configuration of the processing circuit 20 according to another embodiment.

FIG. 10 is a table summarizing whether the compensation can be performed for each of the modes of the processing circuit 20 according to the embodiment of FIG. 9.

FIG. 11 illustrates a configuration of the processing circuit 20 according to another embodiment.

FIG. 12 is a table summarizing whether the compensation can be performed for each of the modes of the processing circuit 20 according to an embodiment of FIG. 11.

FIG. 13 illustrates another example of the wiring of the element 82 included in the memory unit 52.

FIG. 14 illustrates another example of the wiring of the element 82 included in the memory unit 52.

### DESCRIPTION OF EXEMPLARY EMBODIMENTS

Hereinafter, the present invention will be described through embodiments of the invention, but the following embodiments do not limit the invention according to the claims. In addition, not all combinations of the features described in the embodiments necessarily have to be essential to solving means of the invention.

In the following description, a compensation of a detection value of a sensor element will be described as an example, but the present disclosure is not limited to the compensation of the detection value of the sensor element. For example, the present disclosure can be used for a non-volatile memory configured to store compensation data for a characteristic fluctuation of switching elements.

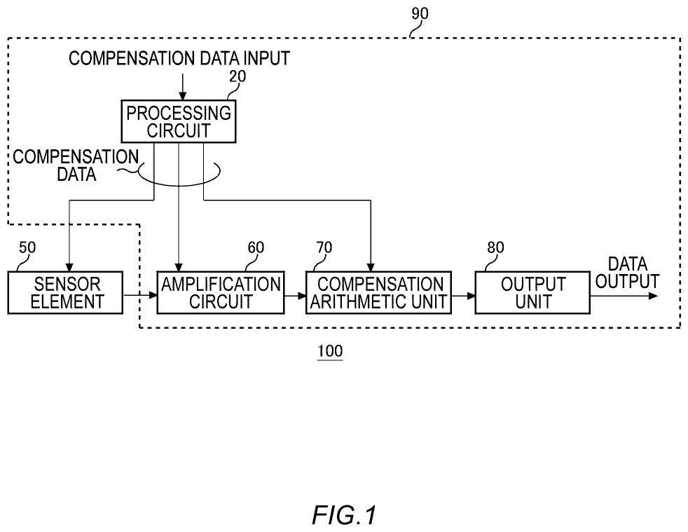

FIG. 1 is a block diagram illustrating an example of a sensor apparatus 100 according to an embodiment of the present invention. As an example, the sensor apparatus 100 is used in various apparatuses used in fields such as automobiles, medical treatment, or manufacturing. The sensor apparatus 100 may include a sensor element 50 configured to detect a predetermined physical quantity such as a pressure sensor or an acceleration sensor, or may be an apparatus configured to process a detection value of the external sensor element 50. The sensor element 50 is an element formed in a semiconductor substrate, for example. In the present example, the sensor element 50 is a pressure sensor.

The sensor apparatus 100 of the present example includes a processing circuit 20, the sensor element 50, and a compensation arithmetic unit 70 (compensation unit). The sensor apparatus 100 may further include at least a part of an amplification circuit 60 and an output unit 80. In addition, the sensor apparatus 100 may be formed of the sensor element 50 formed on a semiconductor substrate, and a semiconductor apparatus 90 formed for components other than the sensor element 50 on the same semiconductor substrate.

The processing circuit 20 is configured to store compensation data for compensating a detection value (compensation target) of the sensor element 50 (pressure sensor). The compensation data is data used for sensitivity adjustment, temperature characteristic adjustment, or the like of the sensor element 50. The processing circuit 20 may be a compensation memory. The compensation data may be input in advance to the processing circuit 20 at the time of shipment or installation of the sensor apparatus 100 or other timing. The compensation data may be generated based on an operation result after the sensor apparatus 100 is caused to operate in a predetermined environment. For example, the compensation data may be data for converting the detection value of the sensor element 50 into an operation result.

The processing circuit 20 may be a non-volatile memory such as, for example, a flash memory, an EPROM, or an EEPROM. The processing circuit 20 may be a combination of a plurality of non-volatile memories and circuits. The processing circuit 20 stores digital data by saving a predetermined physical quantity. As an example, the predetermined physical quantity is a quantity of charge accumulated in a floating gate. The processing circuit 20 may output binary data according to whether the saved physical quantity is a predetermined threshold or more. In the present example, the processing circuit 20 outputs a bit value of “1” when the saved charge is a predetermined threshold or more, and the processing circuit 20 outputs a bit value of “0” when the saved charge is the predetermined threshold or less. The compensation data output by the processing circuit 20 may be temporarily stored in an auxiliary memory such as a register.

The amplification circuit 60 is configured to amplify and output an amplitude of a detection signal output by the sensor element 50. The detection signal is a signal indicating a detection value that has been detected by the sensor element 50. The compensation arithmetic unit 70 is configured to compensate the detection signal output by the amplification circuit 60 by using the compensation data. The output unit 80 is configured to output digital data according to the detection signal compensated by the compensation arithmetic unit 70 as data output indicating the detection value of the sensor element 50. Note that the compensation data may be input to at least one of the sensor element 50 or the amplification circuit 60. The compensation processing using the compensation data may be at least partially performed by the sensor element 50 or the amplification circuit 60.

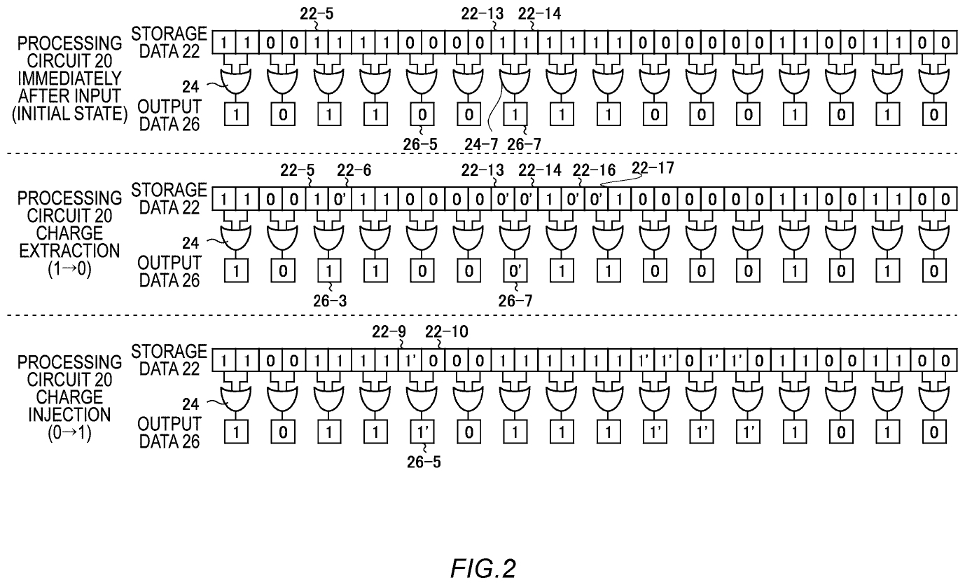

FIG. 2 illustrates a configuration of the processing circuit 20 according to a comparative example. FIG. 2 illustrates each of an (initial) state of the processing circuit 20 immediately after the input, a charge extraction (1 0) state, and a charge injection (0 1) state. In FIG. 2, storage data 22 stored by the processing circuit 20 is set as storage data 22-1 to storage data 22-32 from the left in the stated order, and output data 26 to be output by the processing circuit 20 is set as output data 26-1 to output data 26-16 from the left in the stated order. In FIG. 2, a bit value of the storage data 22-5 is “1”. In FIG. 2, a bit value of the output data 26-5 is “0”. In the present example, the storage data 22 is 32 bits, and the output data 26 is 16 bits. In the present specification, when an error occurs in the bit value of the data, an “apostrophe (')” is added to represent the data like “0′” or “1”.

The physical quantity saved by the processing circuit 20 may fluctuate over time as compared with the data immediately after being written. For example, the charge accumulated in a floating gate can decrease due to natural deterioration caused by discharge or the like, leakage due to an oxide film defect or the like, extraction caused by external noise, or the like. In the case of the charge extraction, the bit value of the data changes from “1” to “0′”. In addition, charge may be injected due to external noise. In the case of the charge injection, the bit value of the data changes from “0” to “1′”.

In the present example, the processing circuit 20 includes OR circuits 24. The OR circuit 24 is configured to output a logical disjunction of two pieces of the storage data 22 as the output data 26. In FIG. 2, the OR circuits 24 are set as an OR circuit 24-1 to an OR circuit 24-16 from the left in the stated order. In FIG. 2, the OR circuit 24-n is configured to output a logical disjunction of the storage data 22-(2n−1) and the storage data 22-2n as the output data 26-n (n is an integer from 1 to 16). For example, the OR circuit 24-7 outputs a logical disjunction of the storage data 22-13 and the storage data 22-14 as the output data 26-7. In the (initial) state immediately after the input, since an error is not occurring, a same bit value is stored in the storage data 22-(2n−1) and the storage data 22-2n.

Next, a case where the charge extraction has occurred will be described. For example, when an error has occurred in the storage data 22-6, the bit value of the storage data 22-6 becomes “0′”. In this case, since an error is not occurring in the bit value of the storage data 22-5 which is to be used to calculate a logical disjunction together with the storage data 22-6, the bit value of the output data 26-3 becomes “1” that is the same as that in the (initial) state immediately after the input. In this manner, when the charge extraction has occurred in the comparative example of FIG. 2, since two pieces of the storage data 22 are input to the OR circuit 24 for each bit to obtain the output data 26, even in a case where the charge extraction has occurred in either piece of the storage data 22, the output of the output data 26 can be maintained.

When an error has occurred in the storage data 22-13 and the storage data 22-14, the bit value of the storage data 22-13 and the bit value of the storage data 22-14 become “0′”. In this case, when a logical disjunction of the storage data 22-13 and the storage data 22-14 is calculated, the bit value of the output data 26-7 becomes “0′” which is different from that in the (initial) state immediately after the input. Accordingly, when the charge extraction has occurred consecutively in two bits in the storage data 22, an error may occur in the output data 26. Note that when the charge extraction has occurred in the storage data 22 like the storage data 22-16 and the storage data 22-17 which are not used to calculate a logical disjunction with each other, an error does not occur in the output data 26 as long as an error is not occurring in the other piece of the storage data 22 which is used together to calculate the logical disjunction.

Next, a case where the charge injection has occurred will be described. For example, when an error has occurred in the storage data 22-9, the bit value of the storage data 22-9 becomes “1′”. In this case, when a logical disjunction is calculated with the storage data 22-10, the bit value of the output data 26-5 becomes “1′” which is different from that in the (initial) state immediately after the input.

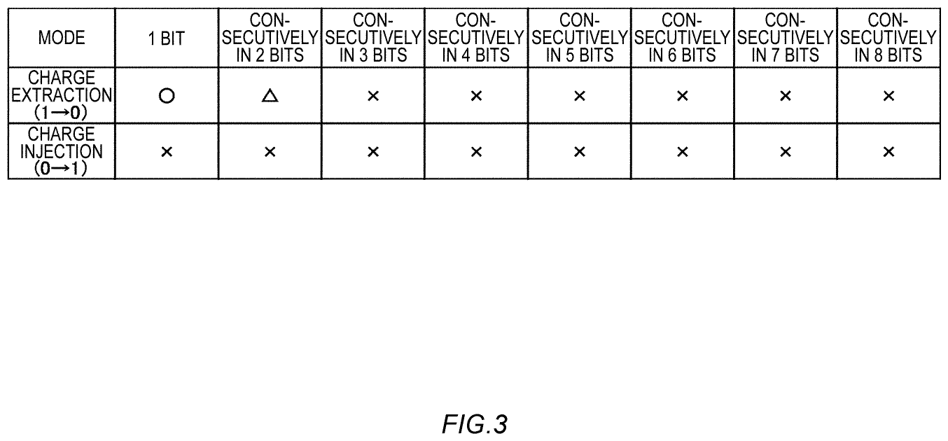

FIG. 3 is a table summarizing whether the compensation can be performed for each of the modes of the processing circuit 20 according to the comparative example of FIG. 2. In a case where the charge extraction has occurred, when an error is occurring in only one bit, the error can be compensated. That is, an error does not occur in the output data 26. In a case where the charge extraction has occurred, when an error is occurring consecutively in two bits, an error may occur in the output data 26. In a case where the charge extraction has occurred, when an error is occurring consecutively in three bits, an error occurs in the output data 26. In addition, in a case where the charge injection has occurred, even when an error is occurring in only one bit, an error occurs in the output data 26.

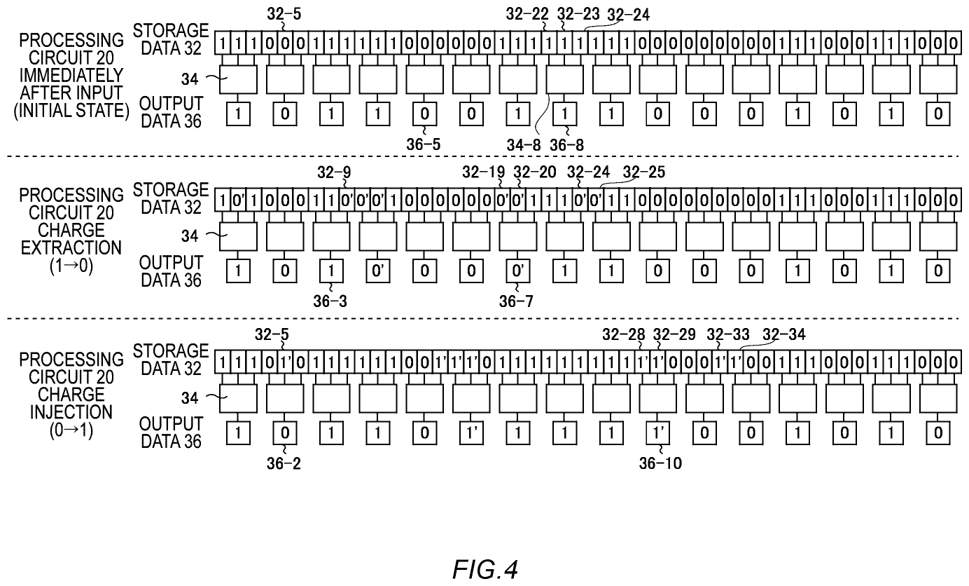

FIG. 4 illustrates a configuration of the processing circuit 20 according to another comparative example. FIG. 4 illustrates each of the (initial) state of the processing circuit 20 immediately after the input, the charge extraction (1→0) state, and the charge injection (0→1) state. In FIG. 4, storage data 32 stored by the processing circuit 20 is set as storage data 32-1 to storage data 32-48 from the left in the stated order, and output data 36 to be output by the processing circuit 20 is set as output data 36-1 to output data 36-16 from the left in the stated order. In FIG. 4, the bit value of the storage data 32-5 is “0”. In FIG. 4, the bit value of the output data 36-5 is “0”. In the present example, the storage data 32 is 48 bits, and the output data 36 is 16 bits.

In the present example, the processing circuit 20 includes majority circuits 34. The majority circuit 34 is configured to output a majority vote of three pieces of the storage data 32 as the output data 36. For example, when the bit values of the three pieces of the storage data 32 are “1”, “0”, and “0”, the bit value of the output data becomes “0”. In FIG. 4, the majority circuits 34 are set as a majority circuit 34-1 to a majority circuit 34-16 from the left in the stated order. In FIG. 4, the majority circuit 34-n is configured to output a majority vote of the storage data 32-(3n−2), the storage data 32-(3n−1), and the storage data 32-3n as the output data 36-n (n is an integer from 1 to 16). For example, the majority circuit 34-8 outputs a majority vote of the storage data 32-22, the storage data 32-23, and the storage data 32-24 as the output data 36-8. In the (initial) state immediately after the input, since an error is not occurring, a same bit value is stored in the storage data 32-(3n−2), the storage data 32-(3n−1), and the storage data 32-3n.

Next, a case where the charge extraction has occurred will be described. For example, when an error has occurred in the storage data 32-9, the bit value of the storage data 32-9 becomes “0′”. In this case, since an error is not occurring in the bit values of the remaining two pieces of the storage data 32 which are used to calculate a majority vote together with the storage data 32-9, the bit value of the output data 36-3 becomes “1” which is the same as that in the (initial) state immediately after the input. In this manner, in a case where the charge extraction has occurred in the comparative example of FIG. 4, since a majority vote of three pieces of the storage data 32 is used as the output data 36 for each bit, even when the charge extraction has occurred in one piece of the storage data 32, the output of the output data 36 can be maintained. However, since the number of the storage data 32 is increased in the comparative example of FIG. 4, a write circuit area of the storage data 32 is increased.

When an error has occurred in the storage data 32-19 and the storage data 32-20, the bit value of the storage data 32-19 and the bit value of the storage data 32-20 become “0′”. In this case, when a majority vote is calculated, the bit value of the output data 36-7 becomes “0′” which is different from that in the (initial) state immediately after the input. Accordingly, when the charge extraction has occurred consecutively in two bits in the storage data 32, an error may occur in the output data 36. Note that when the charge extraction has occurred in the storage data 32 like the storage data 32-24 and the storage data 32-25 which are not used to calculate a majority vote with each other, an error does not occur in the output data 36 as long as an error is not occurring in the other pieces of the storage data 32 which are used together to calculate the majority vote.

Next, a case where the charge injection has occurred will be described. For example, when an error has occurred in the storage data 32-5, the bit value of the storage data 32-5 becomes “1′”. In this case, since an error is not occurring in the bit values of the remaining two pieces of the storage data 32 which are used to calculate a majority vote together with the storage data 32-5, the bit value of the output data 36-2 becomes “0” which is the same as that in the (initial) state immediately after the input. In this manner, since a majority vote of three pieces of the storage data 32 is set as the output data 36 for each bit in the comparative example of FIG. 4, even when the charge injection has occurred in one piece of the storage data 32, the output of the output data 36 can be maintained.

When an error has occurred in the storage data 32-28 and the storage data 32-29, the bit value of the storage data 32-28 and the bit value of the storage data 32-29 become “1′”. In this case, when a majority vote is calculated, the bit value of the output data 36-10 becomes “1′” which is different from that in the (initial) state immediately after the input. Accordingly, when the charge injection has occurred consecutively in two bits in the storage data 32, an error may occur in the output data 36. Note that when the charge injection has occurred in the storage data 32 like the storage data 32-33 and the storage data 32-34 which are not used to calculate a majority vote with each other, an error does not occur in the output data 36 as long as an error is not occurring in the other pieces of the storage data 32 which are used together to calculate the majority vote.

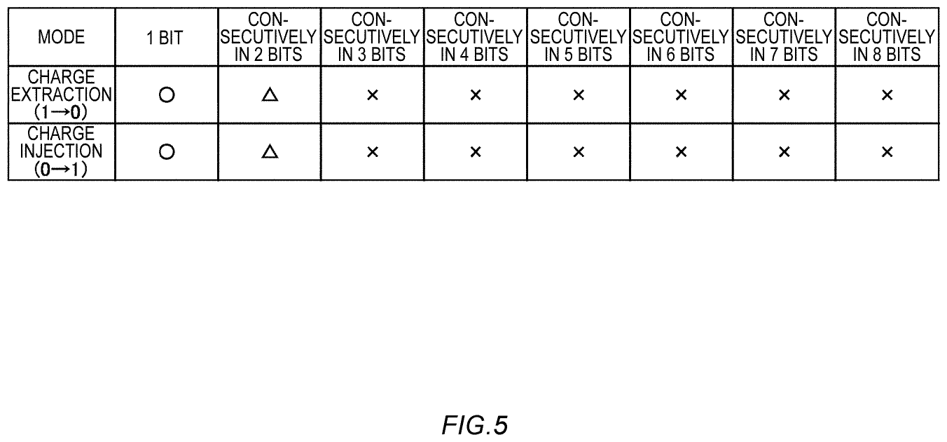

FIG. 5 is a table summarizing whether the compensation can be performed for each of the modes of the processing circuit 20 according to the comparative example of FIG. 4. In the case of both the charge extraction and the charge injection, when an error is occurring in only one bit, the error can be compensated. That is, an error does not occur in the output data 36. In the case of both the charge extraction and the charge injection, when an error is occurring consecutively in two bits, an error may occur in the output data 36. In the case of both the charge extraction and the charge injection, when an error is occurring consecutively in three bits, an error occurs in the output data 36.

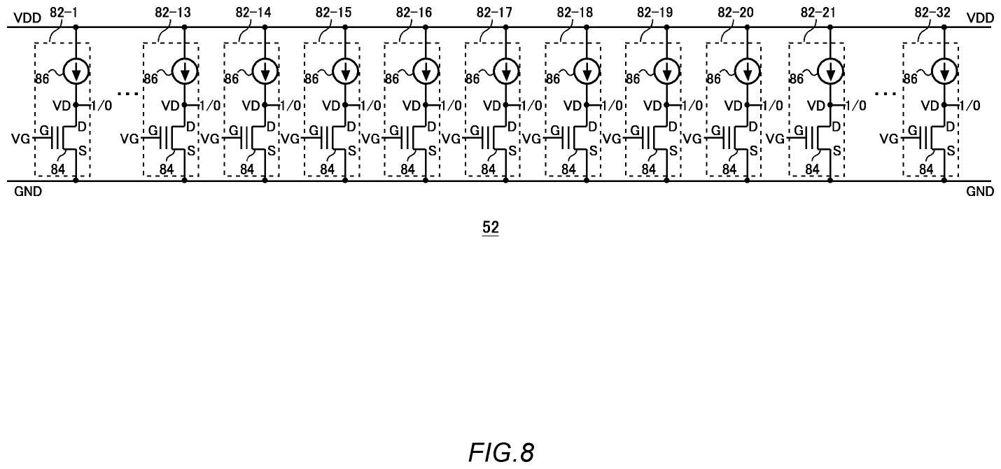

As described above, in the case of the processing circuit 20 of FIG. 2 and FIG. 4 according to the comparative example, when an error occurs consecutively in two bits, an error may occur in the output data, and it is not possible to guarantee redundancy. In addition, when the storage data is combined as in the processing circuit 20 of FIG. 2 and FIG. 4 according to the comparative example, to increase wiring efficiency and suppress an increase in the size and number of IC chips, it is common to combine adjacent EPROMs or EPROMs arranged in close proximity on a semiconductor substrate with each other. In the case of the natural deterioration due to discharge or the like, since the charge of all the EPROMs is extracted in the same manner, the redundancy is not obtained. In addition, in the case of the leakage due to the oxide film defect or the like, this is a leakage path due to a minute crystal defect in the oxide film in the EPROM with a low charge retention property. Accordingly, since a probability that this crystal defect is simultaneously generated in adjacent EPROMs is not largely different from a probability that this crystal defect is simultaneously generated in EPROMs which are not adjacent to each other, the redundancy is also obtained when the adjacent EPROMs are combined with each other. In addition, an influence of the external noise is on a same level in the adjacent EPROMs. Since the charge extraction from the floating gate or the charge injection to the floating gate due to the external noise occurs substantially in a same manner in the adjacent EPROMs and a plurality of adjacent EPROMs simultaneously change, the redundancy is not obtained. Accordingly, by an addition of a simple logic circuit, without an increase in the number of EPROMs, the compensation data can be preferably retained even when an error has occurred in the bit value of the data of the single EPROM or the bit values of the data of the plurality of consecutive EPROMs. Note that a term “adjacent” will be described with reference to FIG. 8.

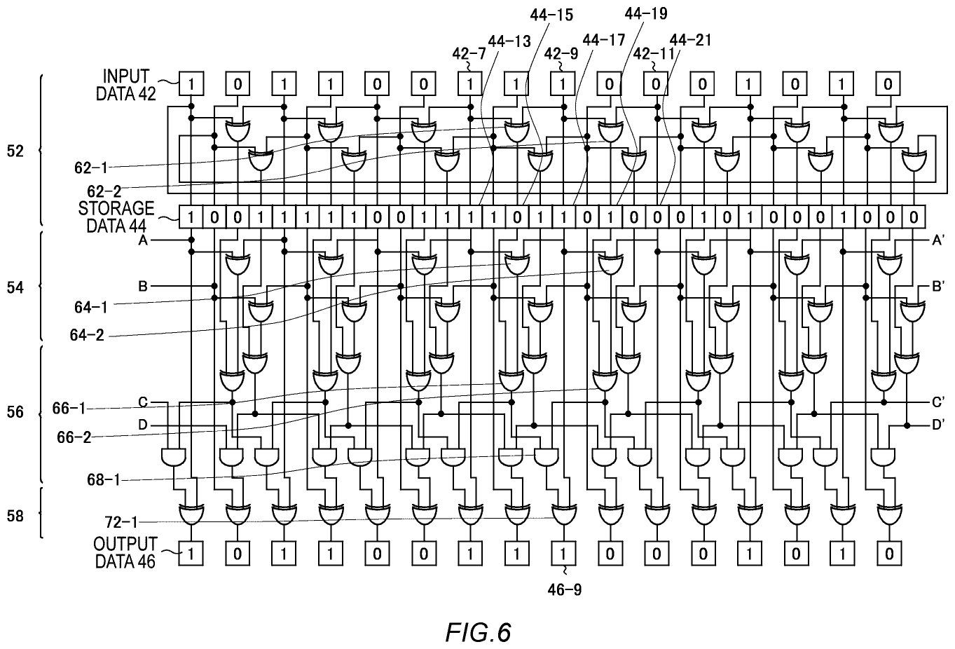

FIG. 6 illustrates a configuration of the processing circuit 20 according to an embodiment. FIG. 6 illustrates an (initial) state of the processing circuit 20 immediately after the input. The processing circuit 20 of FIG. 6 includes a memory unit 52, a code generation unit 54, a determination unit 56, and a correction unit 58. In FIG. 6, input data 42 to be input to the processing circuit 20 is set as input data 42-1 to input data 42-16 from the left in the stated order, and output data 46 to be output by the processing circuit 20 is set as output data 46-1 to output data 46-16 from the left in the stated order. In FIG. 6, the bit value of the input data 42-9 is “1”. In FIG. 6, the bit value of the output data 46-9 is “1”. In FIG. 6, an example in which the processing circuit 20 outputs a bit value of the input data 42-9 will be described. Processing similar to that in the input data 42-9 may be performed also in another piece of the input data 42. In FIG. 6, “A”, “B”, “C”, and “D” in the wiring are respectively connected to “A′”, “B′”, “C′”, and “D′” in the wiring.

The memory unit 52 is configured to store storage data 44. The storage data 44 to be stored by the memory unit 52 is set as storage data 44-1 to storage data 44-32 from the left in the stated order. The storage data 44 includes a bit value of each bit of the input data 42 and a logical exclusive disjunction of bit values of two specific pieces of the input data 42. In the calculation of the logical exclusive disjunction, a code indicating whether the bit values are identical is to be output. That is, an output of the logical exclusive disjunction becomes “1” when the bit values of the two specific pieces of the input data 42 are different from each other, and the output of the logical exclusive disjunction becomes “0” when the bit values of the two specific pieces of the input data 42 are identical. The logical exclusive disjunction of the bit values of the two specific pieces of the input data 42 is a logical exclusive disjunction of the bit value of every other piece of the arranged input data 42 in the present example. Specifically, the storage data 44 of FIG. 6 includes a logical exclusive disjunction of the bit value of the input data 42-7 and the bit value of the input data 42-9 and a logical exclusive disjunction of the bit value of the input data 42-9 and the bit value of the input data 42-11.

The storage data 44 in connection to the input data 42-9 will be described. The bit value of the input data 42-7 is stored in the storage data 44-13. The input data 42-7 is an example of a first bit. In FIG. 6, the bit value of the storage data 44-13 is “1”. The bit value of the input data 42-9 is stored in the storage data 44-17. The input data 42-9 is an example of a second bit. In FIG. 6, the bit value of the storage data 44-17 is “1”. The bit value of the input data 42-11 is stored in the storage data 44-21. The input data 42-11 is an example of a third bit. In FIG. 6, the bit value of the storage data 44-21 is “0”. The processing circuit 20 is configured to process the input data 42 of multiple bits including the first bit, the second bit, and the third bit.

A code indicating whether the bit value of the input data 42-7 and the bit value of the input data 42-9 are identical is stored in the storage data 44-15. In the present example, an exclusive OR circuit 62-1 is configured to output a logical exclusive disjunction of the bit value of the input data 42-7 and the bit value of the input data 42-9 to the storage data 44-15. The storage data 44-15 is an example of a first memory code. The bit value of the storage data 44-15 is “0”. The first memory code may be a logical exclusive disjunction of the bit value of the first bit and the bit value of the second bit. A code indicating whether the bit value of the input data 42-9 and the bit value of the input data 42-11 are identical is stored in the storage data 44-19. In the present example, an exclusive OR circuit 62-2 is configured to output a logical exclusive disjunction of the bit value of the input data 42-9 and the bit value of the input data 42-11 to the storage data 44-19. The storage data 44-19 is an example of a second memory code. The bit value of the storage data 44-19 is “1”. The second memory code may be a logical exclusive disjunction of the bit value of the second bit and the bit value of the third bit. To summarize the above, the memory unit 52 stores the first bit, the second bit, the third bit, the first memory code, and the second memory code.

The code generation unit 54 is configured to generate a generation code indicating whether two specific pieces of the input data 42 stored by the memory unit 52 are identical. In the present example, the code generation unit 54 generates a first generation code indicating whether the bit value of the first bit stored by the memory unit 52 and the bit value of the second bit stored by the memory unit 52 are identical, and a second generation code indicating whether the bit value of the second bit stored by the memory unit 52 and the bit value of the third bit stored by the memory unit 52 are identical. In the present example, the code generation unit 54 includes an exclusive OR circuit 64-1 and an exclusive OR circuit 64-2. In the present example, the exclusive OR circuit 64-1 is configured to output a logical exclusive disjunction of the bit value of the storage data 44-13 and the bit value of the storage data 44-17. An output of the exclusive OR circuit 64-1 is an example of the first generation code. The first generation code may be a logical exclusive disjunction of the bit value of the first bit stored by the memory unit 52 and the bit value of the second bit stored by the memory unit 52. In the present example, the exclusive OR circuit 64-2 is configured to output a logical exclusive disjunction of the bit value of the storage data 44-17 and the bit value of the storage data 44-21. An output of the exclusive OR circuit 64-2 is an example of the second generation code. The second generation code may be a logical exclusive disjunction of the bit value of the second bit stored by the memory unit 52 and the bit value of the third bit stored by the memory unit 52.

The determination unit 56 is configured to determine whether, based on a result of a comparison between the first memory code and the first generation code and a result a comparison between the second memory code and the second generation code, an error has occurred in the bit value of the second bit (the storage data 44-17) stored by the memory unit 52. In the present example, the determination unit 56 determines whether, based on a logical conjunction of the result of the comparison between the first memory code and the first generation code and the result of the comparison between the second memory code and the second generation code, an error has occurred in the bit value of the second bit (the storage data 44-17) stored by the memory unit 52. In the present example, the determination unit 56 includes an exclusive OR circuit 66-1, an exclusive OR circuit 66-2, and an AND circuit 68-1. In the present example, the exclusive OR circuit 66-1 is configured to output a logical exclusive disjunction of the bit value of the first memory code (the storage data 44-15) and the bit value of the first generation code (the output of the exclusive OR circuit 64-1). The exclusive OR circuit 66-1 is an example of a first exclusive OR circuit. In the present example, the exclusive OR circuit 66-2 is configured to output a logical exclusive disjunction of the bit value of the second memory code (the storage data 44-19) and the bit value of the second generation code (the output of the exclusive OR circuit 64-2). The exclusive OR circuit 66-2 is an example of a second exclusive OR circuit. The AND circuit 68-1 is configured to output a logical conjunction of an output of the exclusive OR circuit 66-1 and an output of the exclusive OR circuit 66-2.

A determination method of the determination unit 56 will be described. First, a case where an error is not occurring in the storage data 44 will be described. The bit value of the first memory code (the storage data 44-15) and the bit value of the first generation code (the output of the exclusive OR circuit 64-1) become identical. Accordingly, the bit value of the output of the exclusive OR circuit 66-1 is “0”. Similarly, when an error is not occurring in the storage data 44, the bit value of the second memory code (the storage data 44-19) and the bit value of the second generation code (the output of the exclusive OR circuit 64-2) become identical. Accordingly, the bit value of the output of the exclusive OR circuit 66-2 is “0”. Therefore, the bit value of the output of the AND circuit 68-1 is “0”. When the bit value of the output of the AND circuit 68-1 is “0”, the determination unit 56 determines that an error is not occurring in the bit value of the second bit (the storage data 44-17) stored by the memory unit 52.

Next, a case where an error is occurring in the storage data 44 will be described. For example, when an error is occurring in only the bit value of the second bit (the storage data 44-17) stored by the memory unit 52, the bit value of the first memory code (the storage data 44-15) and the bit value of the first generation code (the output of the exclusive OR circuit 64-1) are different from each other. Accordingly, the bit value of the output of the exclusive OR circuit 66-1 is “1”. Similarly, when an error is occurring in only the bit value of the second bit (the storage data 44-17) stored by the memory unit 52, the bit value of the second memory code (the storage data 44-19) and the bit value of the second generation code (the output of the exclusive OR circuit 64-2) are different from each other. Accordingly, the bit value of the output of the exclusive OR circuit 66-2 is “1”. Therefore, the bit value of the output of the AND circuit 68-1 is “1”. When the bit value of the output of the AND circuit 68-1 is “1”, the determination unit 56 determines that an error is occurring in the bit value of the second bit (the storage data 44-17) stored by the memory unit 52.

In addition, when an error is occurring in the storage data 44, only either the bit value of the output of the exclusive OR circuit 66-1 or the bit value of the output of the exclusive OR circuit 66-2 may be “1”. In this case, the bit value of the output of the AND circuit 68-1 is “0”, and the determination unit 56 determines that an error is not occurring in the bit value of the second bit (the storage data 44-17) stored by the memory unit 52. For example, when the bit value of the output of the exclusive OR circuit 66-1 is “1” and the bit value of the output of the exclusive OR circuit 66-2 is “0”, the determination unit 56 determines that an error is not occurring in the bit value of the second bit (the storage data 44-17) stored by the memory unit 52, and determines that an error is being generated in either the storage data 44-13 or the storage data 44-15. Similarly, when the bit value of the output of the exclusive OR circuit 66-1 is “0” and the bit value of the output of the exclusive OR circuit 66-2 is “1”, the determination unit 56 determines that an error is not occurring in the bit value of the second bit (the storage data 44-17) stored by the memory unit 52, and determines that an error is being generated in either the storage data 44-19 or the storage data 44-21.

To summarize the above, the determination unit 56 may determine that an error has occurred in the bit value of the second bit (the storage data 44-17) stored by the memory unit 52 when the first memory code (the storage data 44-15) and the first generation code (the output of the exclusive OR circuit 64-1) are different from each other and also when the second memory code (the storage data 44-19) and the second generation code (the output of the exclusive OR circuit 64-2) are different from each other. In addition, the determination unit 56 determines that the bit value of the second bit (the storage data 44-17) stored by the memory unit 52 is correct when the first memory code (the storage data 44-15) and the first generation code (the output of the exclusive OR circuit 64-1) are identical or when the second memory code (the storage data 44-19) and the second generation code (the output of the exclusive OR circuit 64-2) are identical. In another example, the determination unit 56 may determine that the bit value of the second bit (the storage data 44-17) stored by the memory unit 52 is correct when the first memory code (the storage data 44-15) and the first generation code (the output of the exclusive OR circuit 64-1) are different from each other and also when the second memory code (the storage data 44-19) and the second generation code (the output of the exclusive OR circuit 64-2) are different from each other, and determine that an error has occurred in the bit value of the second bit (the storage data 44-17) stored by the memory unit 52 when the first memory code (the storage data 44-15) and the first generation code (the output of the exclusive OR circuit 64-1) are identical or when the second memory code (the storage data 44-19) and the second generation code (the output of the exclusive OR circuit 64-2) are identical. In addition, an inverting circuit may be provided in either an input of the exclusive OR circuit 66-1 or an input of the exclusive OR circuit 66-2.

The correction unit 58 is configured to correct and output the bit value of the second bit (the storage data 44-17) stored by the memory unit 52 when the determination unit 56 determines that an error has occurred in the bit value of the second bit (the storage data 44-17) stored by the memory unit 52. In the present example, the correction unit 58 includes an exclusive OR circuit 72-1. The exclusive OR circuit 72-1 is configured to output a logical exclusive disjunction of the bit value of the second bit (the storage data 44-17) stored by the memory unit 52 and the bit value of the output of the AND circuit 68-1 to the output data 46-9. For example, when the determination unit 56 determines that an error is occurring in the bit value of the second bit (the storage data 44-17) stored by the memory unit 52, since the bit value of the output of the AND circuit 68-1 is “1”, the bit value of the second bit (the storage data 44-17) stored by the memory unit 52 is output by being inverted. That is, in a case where the determination unit 56 determines that an error is occurring in the bit value of the second bit (the storage data 44-17) stored by the memory unit 52, “0” is the output to the output data 46-9 when the bit value of the second bit (the storage data 44-17) is “1”, and “1” is output to the output data 46-9 when the bit value of the second bit (the storage data 44-17) is “0”. When the determination unit 56 determines that an error is not occurring in the bit value of the second bit (the storage data 44-17) stored by the memory unit 52, since the bit value of the output of the AND circuit 68-1 is “0”, the bit value of the second bit (the storage data 44-17) stored by the memory unit 52 is output to the output data 46-9. In FIG. 6, since an error is not occurring in the bit value of the second bit (the storage data 44-17), the bit value of the second bit (the storage data 44-17) is output to the output data 46-9 as it is.

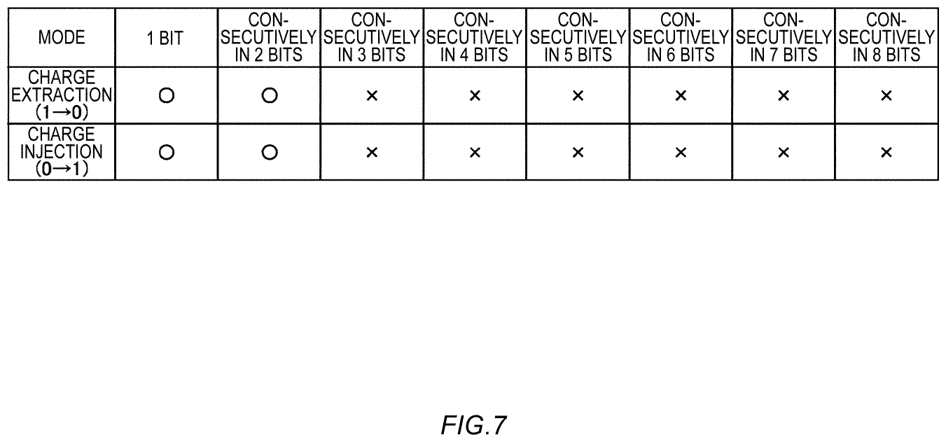

FIG. 7 is a table summarizing whether the compensation can be performed for each of the modes of the processing circuit 20 according to the embodiment of FIG. 6. As described with reference to FIG. 6, to output the output data 46-9, each of the bit values of the storage data 44-13, the storage data 44-15, the storage data 44-17, the storage data 44-19, and the storage data 44-21 is used. Accordingly, since the pieces of the storage data 44 to be used for the correction are not arranged to be adjacent to each other, an error occurring consecutively in up to two bits is correctable in the case of either the charge extraction or the charge injection. In addition, the storage data 44 of FIG. 6 is 32 bits, which is the same as the storage data 22 of the comparative example in FIG. 2. Accordingly, without the increase in the number of EPROMs, the compensation data can be retained even when an error has occurred in the bit value of the data of the single EPROM or the bit values of the data of the plurality of consecutive EPROMs (up to two consecutive EPROMs in the case of FIG. 6).

FIG. 8 illustrates an example of a wiring of an element 82 included in the memory unit 52. The memory unit 52 includes a plurality of elements 82. Each of the elements 82 is configured to function as an EPROM. Each of the elements 82 stores a bit value of each bit of the data. In the present example, an element 82-n stores the storage data 44-n (n is an integer from 1 to 32).

The element 82 includes a switching element 84 and a constant current source 86. The constant current source 86 is connected to a drain terminal D of the switching element 84. The switching element 84 of the present example is a MOSFET including a floating gate. The drain terminal D of the switching element 84 is connected to a high potential line VDD via the constant current source 86, and a source terminal S is connected to a reference potential line GND. A predetermined gate voltage VG is applied to a gate terminal G of the switching element 84. In a state where charge is not accumulated at the floating gate of the switching element 84, the switching element 84 turns on by the gate voltage VG to allow a current sufficiently larger than a constant current of the constant current source 86 to flow, and a drain voltage becomes a voltage close to a potential of the reference potential line GND. On the other hand, in a state where charge is accumulated at the floating gate of the switching element 84, the switching element 84 does not turn on by the gate voltage VG, and the drain voltage becomes a voltage close to a potential of the high potential line VDD by a current of the constant current source 86. That is, the voltage of the drain terminal D is determined depending on the presence or absence of the accumulated charge at the floating gate of the switching element 84, data of the bit is decided. That is, the drain terminal D is configured to function as an output terminal of the element 82. The code generation unit 54 generates the first generation code and the second generation code from the a bit value of each bit of the data output from the drain terminal D of the element 82. The respective elements 82 in the plurality of the elements 82 are provided in parallel between the high potential line VDD and the reference potential line GND. The element 82-1 to the element 82-32 may be provided in parallel in this order between the high potential line VDD and the reference potential line GND.

In FIG. 8, the element 82-13 configured to store the bit value of the first bit, the element 82-17 configured to store the bit value of the second bit, and the element 82-21 configured to store the bit value of the third bit are not arranged to be adjacent to each other. A state where the elements 82 are not arranged to be adjacent to each other refers to a state where another element 82 is arranged between the two elements 82. A state of not being arranged to be adjacent to each other may be a state where another element 82 is arranged between the two elements 82 in an electric wiring direction as illustrated in FIG. 8. A state of not being arranged to be adjacent to each other may be a state where another element 82 is arranged between the two elements 82 which are spatially arranged (for example, arranged in the semiconductor apparatus 90). A configuration may be adopted where the element 82 configured to store the bit value of the first bit, the element 82 configured to store the bit value of the second bit, and the element 82 configured to store the bit value of the third bit are not arranged to be adjacent to each other. Furthermore, a configuration may be adopted where the element 82-13, the element 82-15, the element 82-17, the element 82-19, and the element 82-21, which include the element 82-15 configured to store the first memory code and the element 82-19 configured to store the second memory code, are not arranged to be adjacent to each other.

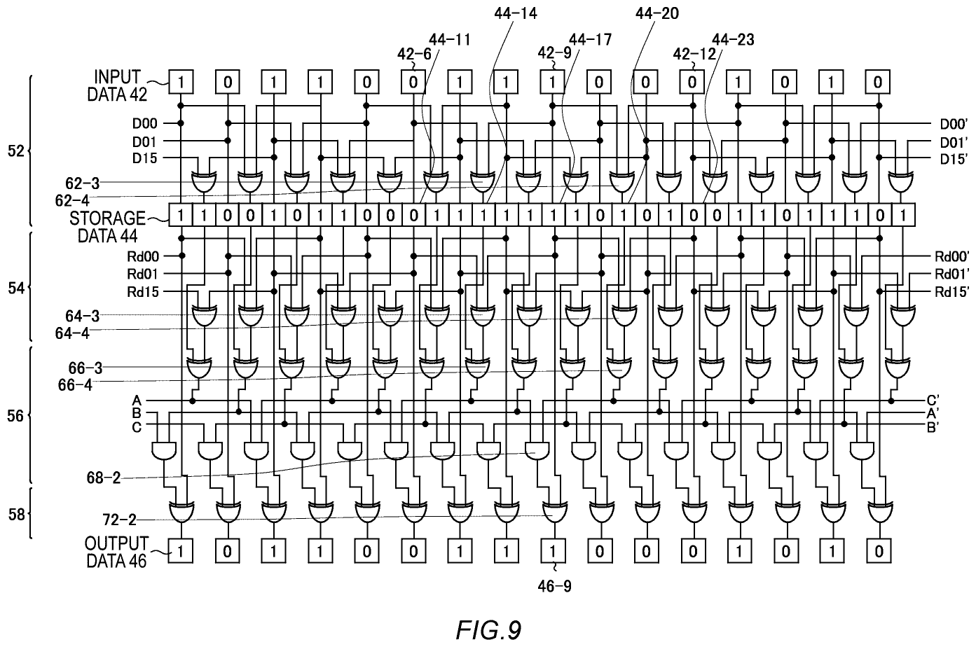

FIG. 9 illustrates a configuration of the processing circuit 20 according to another embodiment. FIG. 9 illustrates an (initial) state of the processing circuit 20 immediately after the input. The processing circuit 20 of FIG. 9 includes the memory unit 52, the code generation unit 54, the determination unit 56, and the correction unit 58. In FIG. 9, a description of a reference sign used in common in FIG. 6 will be omitted. In FIG. 9, an example in which the processing circuit 20 outputs the bit value of the input data 42-9 will be described. Processing similar to that in the input data 42-9 may be performed also in another piece of the input data 42. In FIG. 9, “D00”, “D01”, “D15”, “Rd00”, “Rd01”, “Rd15”, “A”, “B”, and “C” in the wiring are respectively connected to “D00′”, “D01′”, “D15′”, “Rd00′”, “Rd01′”, “Rd15′”, “A′”, “B′”, and “C′” in the wiring.

The storage data 44 includes a bit value of each bit of the input data 42 and a logical exclusive disjunction of bit values of two specific pieces of the input data 42. In the calculation of the logical exclusive disjunction, a code indicating whether the bit values are identical is to be output. The logical exclusive disjunction of the bit values of the two specific pieces of the input data 42 is a logical exclusive disjunction of the bit value of every third piece of the arranged input data 42 in the present example. Specifically, the storage data 44 of FIG. 9 includes a logical exclusive disjunction of the bit value of the input data 42-6 and the bit value of the input data 42-9 and a logical exclusive disjunction of the bit value of the input data 42-9 and the bit value of the input data 42-12.

The storage data 44 in connection to the input data 42-9 will be described. The bit value of the input data 42-6 is stored in the storage data 44-11. The input data 42-6 is an example of the first bit. In FIG. 9, the bit value of the storage data 44-11 is “0”. The bit value of the input data 42-9 is stored in the storage data 44-17. The input data 42-9 is an example of the second bit. In FIG. 9, the bit value of the storage data 44-17 is “1”. The bit value of the input data 42-12 is stored in the storage data 44-23. The input data 42-12 is an example of the third bit. In FIG. 9, the bit value of the storage data 44-23 is “0”.

A code indicating whether the bit value of the input data 42-6 and the bit value of the input data 42-9 are identical is stored in the storage data 44-14. In the present example, an exclusive OR circuit 62-3 is configured to output a logical exclusive disjunction of the bit value of the input data 42-6 and the bit value of the input data 42-9 to the storage data 44-14. The storage data 44-14 is an example of the first memory code. The bit value of the storage data 44-14 is “1”. A code indicating whether the bit value of the input data 42-9 and the bit value of the input data 42-12 are identical is stored in the storage data 44-20. In the present example, an exclusive OR circuit 62-4 is configured to output a logical exclusive disjunction of the bit value of the input data 42-9 and the bit value of the input data 42-12 to the storage data 44-20. The storage data 44-20 is an example of the second memory code. The bit value of the storage data 44-20 is “1”.

The code generation unit 54 generates a generation code indicating whether two specific pieces of the input data 42 stored by the memory unit 52 are identical. In the present example, the code generation unit 54 generates a first generation code indicating whether the bit value of the first bit stored by the memory unit 52 and the bit value of the second bit stored by the memory unit 52 are identical, and a second generation code indicating whether the bit value of the second bit stored by the memory unit 52 and the bit value of the third bit stored by the memory unit 52 are identical. In the present example, the code generation unit 54 includes an exclusive OR circuit 64-3 and an exclusive OR circuit 64-4. In the present example, the exclusive OR circuit 64-3 is configured to output a logical exclusive disjunction of the bit value of the storage data 44-11 and the bit value of the storage data 44-17. An output of the exclusive OR circuit 64-3 is an example of the first generation code. In the present example, the exclusive OR circuit 64-4 is configured to output a logical exclusive disjunction of the bit value of the storage data 44-17 and the bit value of the storage data 44-23. An output of the exclusive OR circuit 64-4 is an example of the second generation code.

The determination unit 56 determines whether, based on a result of a comparison between the first memory code and the first generation code and a result a comparison between the second memory code and the second generation code, an error has occurred in the bit value of the second bit (the storage data 44-17) stored by the memory unit 52. In the present example, the determination unit 56 determines whether, based on a logical conjunction of the result of the comparison between the first memory code and the first generation code and the result of the comparison between the second memory code and the second generation code, an error has occurred in the bit value of the second bit (the storage data 44-17) stored by the memory unit 52. In the present example, the determination unit 56 includes an exclusive OR circuit 66-3, an exclusive OR circuit 66-4, and an AND circuit 68-2. In the present example, the exclusive OR circuit 66-3 is configured to output a logical exclusive disjunction of the bit value of the first memory code (the storage data 44-14) and the bit value of the first generation code (the output of the exclusive OR circuit 64-3). In the present example, the exclusive OR circuit 66-4 is configured to output a logical exclusive disjunction of the bit value of the second memory code (the storage data 44-20) and the bit value of the second generation code (the output of the exclusive OR circuit 64-4). The AND circuit 68-2 is configured to output a logical conjunction of an output of the exclusive OR circuit 66-3 and an output of the exclusive OR circuit 66-4.

A determination method of the determination unit 56 will be described. First, a case where an error is not occurring in the storage data 44 will be described. The bit value of the first memory code (the storage data 44-14) and the bit value of the first generation code (the output of the exclusive OR circuit 64-3) become identical. Accordingly, the bit value of the output of the exclusive OR circuit 66-3 is “0”. Similarly, when an error is not occurring in the storage data 44, the bit value of the second memory code (the storage data 44-20) and the bit value of the second generation code (the output of the exclusive OR circuit 64-4) become identical. Accordingly, the bit value of the output of the exclusive OR circuit 66-4 is “0”. Therefore, the bit value of the output of the AND circuit 68-2 is “0”. When the bit value of the output of the AND circuit 68-2 is “0”, the determination unit 56 determines that an error is not occurring in the bit value of the second bit (the storage data 44-17) stored by the memory unit 52.

Next, a case where an error is occurring in the storage data 44 will be described. For example, when an error is occurring in only the bit value of the second bit (the storage data 44-17) stored by the memory unit 52, the bit value of the first memory code (the storage data 44-14) and the bit value of the first generation code (the output of the exclusive OR circuit 64-3) are different from each other. Accordingly, the bit value of the output of the exclusive OR circuit 66-3 is “1”. Similarly, when an error is occurring in only the bit value of the second bit (the storage data 44-17) stored by the memory unit 52, the bit value of the second memory code (the storage data 44-20) and the bit value of the second generation code (the output of the exclusive OR circuit 64-4) are different from each other. Accordingly, the bit value of the output of the exclusive OR circuit 66-4 is “1”. Therefore, the bit value of the output of the AND circuit 68-2 is “1”. When the bit value of the output of the AND circuit 68-2 is “1”, the determination unit 56 determines that an error is occurring in the bit value of the second bit (the storage data 44-17) stored by the memory unit 52.

In addition, when an error is occurring in the storage data 44, only either the bit value of the output of the exclusive OR circuit 66-3 or the bit value of the output of the exclusive OR circuit 66-4 may be “1”. In this case, the bit value of the output of the AND circuit 68-2 is “0”, and the determination unit 56 determines that an error is not occurring in the bit value of the second bit (the storage data 44-17) stored by the memory unit 52. For example, when the bit value of the output of the exclusive OR circuit 66-3 is “1” and the bit value of the output of the exclusive OR circuit 66-4 is “0”, the determination unit 56 determines that an error is not occurring in the bit value of the second bit (the storage data 44-17) stored by the memory unit 52, and determines that an error is being generated in either the storage data 44-11 or the storage data 44-14. Similarly, when the bit value of the output of the exclusive OR circuit 66-3 is “0” and the bit value of the output of the exclusive OR circuit 66-4 is “1”, the determination unit 56 determines that an error is not occurring in the bit value of the second bit (the storage data 44-17) stored by the memory unit 52, and determines that an error is being generated in either the storage data 44-20 or the storage data 44-23.

The correction unit 58 corrects and outputs the bit value of the second bit (the storage data 44-17) stored by the memory unit 52 when the determination unit 56 determines that an error has occurred in the bit value of the second bit (the storage data 44-17) stored by the memory unit 52. In the present example, the correction unit 58 includes an exclusive OR circuit 72-2. The exclusive OR circuit 72-2 is configured to output a logical exclusive disjunction of the bit value of the second bit (the storage data 44-17) stored by the memory unit 52 and the bit value of the output of the AND circuit 68-2 to the output data 46-9. For example, when the determination unit 56 determines that an error is occurring in the bit value of the second bit (the storage data 44-17) stored by the memory unit 52, since the bit value of the output of the AND circuit 68-2 is “1”, the bit value of the second bit (the storage data 44-17) stored by the memory unit 52 is output by being inverted. That is, in a case where the determination unit 56 determines that an error is occurring in the bit value of the second bit (the storage data 44-17) stored by the memory unit 52, “0” is the output to the output data 46-9 when the bit value of the second bit (the storage data 44-17) is “1”, and “1” is output to the output data 46-9 when the bit value of the second bit (the storage data 44-17) is “0”. When the determination unit 56 determines that an error is not occurring in the bit value of the second bit (the storage data 44-17) stored by the memory unit 52, since the bit value of the output of the AND circuit 68-2 is “0”, the bit value of the second bit (the storage data 44-17) stored by the memory unit 52 is output to the output data 46-9. In FIG. 9, since an error is not occurring in the bit value of the second bit (the storage data 44-17), the bit value of the second bit (the storage data 44-17) is output to the output data 46-9 as it is.

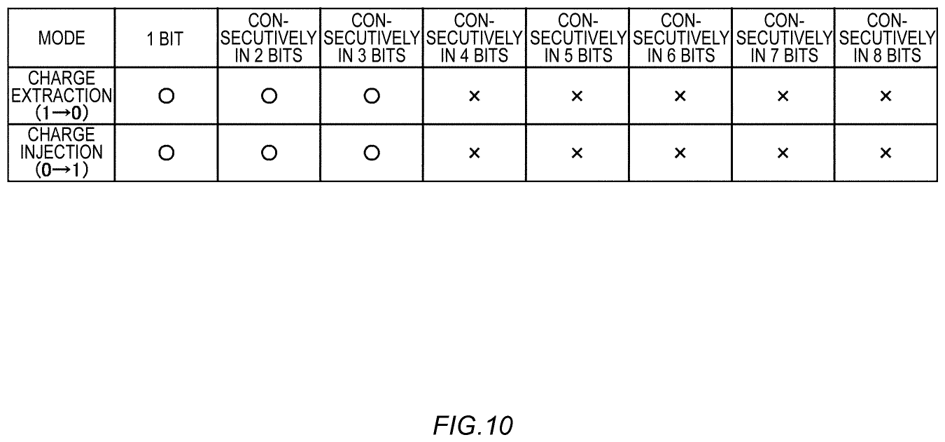

FIG. 10 is a table summarizing whether the compensation can be performed for each of the modes of the processing circuit 20 according to the embodiment of FIG. 9. As described with reference to FIG. 9, to output the output data 46-9, each of the bit values of the storage data 44-11, the storage data 44-14, the storage data 44-17, the storage data 44-20, and the storage data 44-23 is used. Accordingly, since the pieces of the storage data 44 to be used for the correction are not arranged to be adjacent to each other, an error occurring consecutively in up to three bits is correctable in the case of either the charge extraction or the charge injection. In addition, the storage data 44 of FIG. 9 is 32 bits, which is the same as the storage data 22 of the comparative example in FIG. 2. Accordingly, without the increase in the number of EPROMs, the compensation data can be retained even when an error has occurred in the bit value of the data of the single EPROM or the bit values of the data of the plurality of consecutive EPROMs (up to three consecutive EPROMs in the case of FIG. 9).

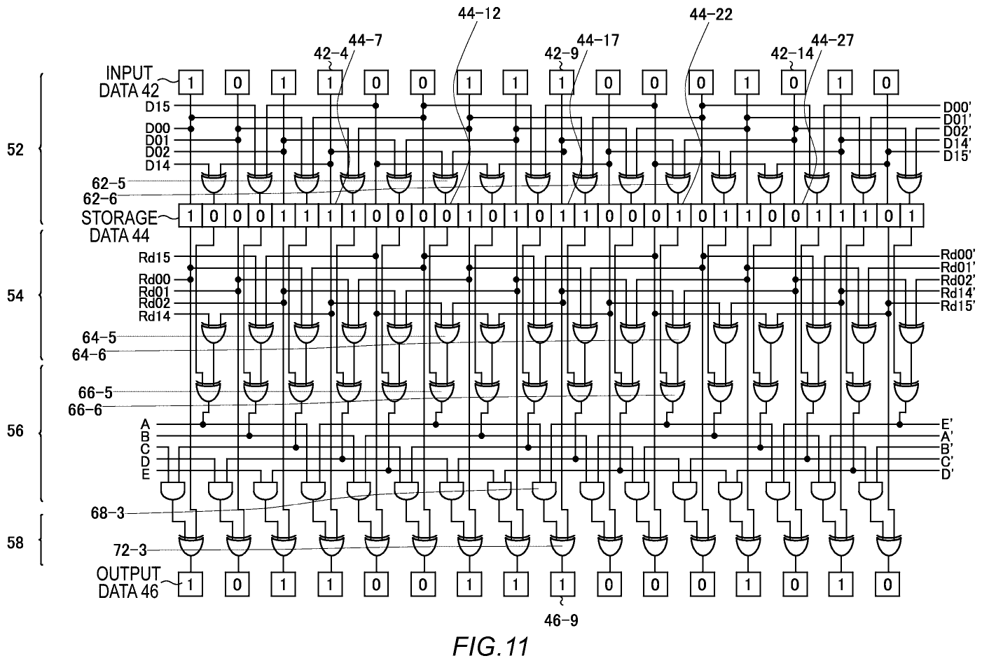

FIG. 11 illustrates a configuration of the processing circuit 20 according to another embodiment. FIG. 11 illustrates an (initial) state of the processing circuit 20 immediately after the input. The processing circuit 20 of FIG. 11 includes the memory unit 52, the code generation unit 54, the determination unit 56, and the correction unit 58. In FIG. 11, a description of a reference sign used in common in FIG. 6 will be omitted. In FIG. 11, an example in which the processing circuit 20 outputs the bit value of the input data 42-9 will be described. Processing similar to that in the input data 42-9 may be performed also in another piece of the input data 42. In FIG. 11, “D00”, “D01”, “D02”, “D14”, “D15”, “Rd00”, “Rd01”, “Rd02”, “Rd14”, “Rd15”, “A”, “B”, “C”, “D”, and “E” in the wiring are respectively connected to “D00′”, “D01′”, “D02′”, “D14′”, “D15′”, “Rd00′”, “Rd01′”, “Rd02′”, “Rd14′”, “Rd15′”, “A′”, “B′”, “C′”, “D′”, and “E′” in the wiring.

The storage data 44 includes a bit value of each bit of the input data 42 and a logical exclusive disjunction of bit values of two specific pieces of the input data 42. In the calculation of the logical exclusive disjunction, a code indicating whether the bit values are identical is to be output. The logical exclusive disjunction of the bit values of the two specific pieces of the input data 42 is a logical exclusive disjunction of the bit value of every fifth piece of the arranged input data 42 in the present example. Specifically, the storage data 44 of FIG. 11 includes a logical exclusive disjunction of the bit value of the input data 42-4 and the bit value of the input data 42-9 and a logical exclusive disjunction of the bit value of the input data 42-9 and the bit value of the input data 42-14.

The storage data 44 in connection to the input data 42-9 will be described. The bit value of the input data 42-4 is stored in the storage data 44-7. The input data 42-4 is an example of the first bit. In FIG. 11, the bit value of the storage data 44-7 is “1”. The bit value of the input data 42-9 is stored in the storage data 44-17. The input data 42-9 is an example of the second bit. In FIG. 11, the bit value of the storage data 44-17 is “1”. The bit value of the input data 42-14 is stored in the storage data 44-27. The input data 42-14 is an example of the third bit. In FIG. 11, the bit value of the storage data 44-27 is “0”.

A code indicating whether the bit value of the input data 42-4 and the bit value of the input data 42-9 are identical is stored in the storage data 44-12. In the present example, an exclusive OR circuit 62-5 is configured to output a logical exclusive disjunction of the bit value of the input data 42-4 and the bit value of the input data 42-9 to the storage data 44-12. The storage data 44-12 is an example of the first memory code. The bit value of the storage data 44-12 is “0”. A code indicating whether the bit value of the input data 42-9 and the bit value of the input data 42-14 are identical is stored in the storage data 44-22. In the present example, an exclusive OR circuit 62-6 is configured to output a logical exclusive disjunction of the bit value of the input data 42-9 and the bit value of the input data 42-14 to the storage data 44-22. The storage data 44-22 is an example of the second memory code. The bit value of the storage data 44-22 is “1”.

The code generation unit 54 generates a generation code indicating whether two specific pieces of the input data 42 stored by the memory unit 52 are identical. In the present example, the code generation unit 54 generates a first generation code indicating whether the bit value of the first bit stored by the memory unit 52 and the bit value of the second bit stored by the memory unit 52 are identical, and a second generation code indicating whether the bit value of the second bit stored by the memory unit 52 and the bit value of the third bit stored by the memory unit 52 are identical. In the present example, the code generation unit 54 includes an exclusive OR circuit 64-5 and an exclusive OR circuit 64-6. In the present example, the exclusive OR circuit 64-5 is configured to output a logical exclusive disjunction of the bit value of the storage data 44-7 and the bit value of the storage data 44-17. An output of the exclusive OR circuit 64-5 is an example of the first generation code. In the present example, the exclusive OR circuit 64-6 is configured to output a logical exclusive disjunction of the bit value of the storage data 44-17 and the bit value of the storage data 44-27. An output of the exclusive OR circuit 64-6 is an example of the second generation code.

The determination unit 56 determines whether, based on a result of a comparison between the first memory code and the first generation code and a result a comparison between the second memory code and the second generation code, an error has occurred in the bit value of the second bit (the storage data 44-17) stored by the memory unit 52. In the present example, the determination unit 56 determines whether, based on a logical conjunction of the result of the comparison between the first memory code and the first generation code and the result of the comparison between the second memory code and the second generation code, an error has occurred in the bit value of the second bit (the storage data 44-17) stored by the memory unit 52. In the present example, the determination unit 56 includes an exclusive OR circuit 66-5, an exclusive OR circuit 66-6, and an AND circuit 68-3. In the present example, the exclusive OR circuit 66-5 is configured to output a logical exclusive disjunction of the bit value of the first memory code (the storage data 44-12) and the bit value of the first generation code (the output of the exclusive OR circuit 64-5). In the present example, the exclusive OR circuit 66-6 is configured to output a logical exclusive disjunction of the bit value of the second memory code (the storage data 44-22) and the bit value of the second generation code (the output of the exclusive OR circuit 64-6). The AND circuit 68-3 is configured to output a logical conjunction of an output of the exclusive OR circuit 66-5 and an output of the exclusive OR circuit 66-6.

A determination method of the determination unit 56 will be described. First, a case where an error is not occurring in the storage data 44 will be described. The bit value of the first memory code (the storage data 44-12) and the bit value of the first generation code (the output of the exclusive OR circuit 64-5) become identical. Accordingly, the bit value of the output of the exclusive OR circuit 66-5 is “0”. Similarly, when an error is not occurring in the storage data 44, the bit value of the second memory code (the storage data 44-22) and the bit value of the second generation code (the output of the exclusive OR circuit 64-6) become identical. Accordingly, the bit value of the output of the exclusive OR circuit 66-6 is “0”. Therefore, the bit value of the output of the AND circuit 68-3 is “0”. When the bit value of the output of the AND circuit 68-3 is “0”, the determination unit 56 determines that an error is not occurring in the bit value of the second bit (the storage data 44-17) stored by the memory unit 52.

Next, a case where an error is occurring in the storage data 44 will be described. For example, when an error is occurring in only the bit value of the second bit (the storage data 44-17) stored by the memory unit 52, the bit value of the first memory code (the storage data 44-12) and the bit value of the first generation code (the output of the exclusive OR circuit 64-5) are different from each other. Accordingly, the bit value of the output of the exclusive OR circuit 66-5 is “1”. Similarly, when an error is occurring in only the bit value of the second bit (the storage data 44-17) stored by the memory unit 52, the bit value of the second memory code (the storage data 44-22) and the bit value of the second generation code (the output of the exclusive OR circuit 64-6) are different from each other. Accordingly, the bit value of the output of the exclusive OR circuit 66-6 is “1”. Therefore, the bit value of the output of the AND circuit 68-3 is “1”. When the bit value of the output of the AND circuit 68-3 is “1”, the determination unit 56 determines that an error is occurring in the bit value of the second bit (the storage data 44-17) stored by the memory unit 52.

In addition, when an error is occurring in the storage data 44, only either the bit value of the output of the exclusive OR circuit 66-5 or the bit value of the output of the exclusive OR circuit 66-6 may be “1”. In this case, the bit value of the output of the AND circuit 68-3 is “0”, and the determination unit 56 determines that an error is not occurring in the bit value of the second bit (the storage data 44-17) stored by the memory unit 52. For example, when the bit value of the output of the exclusive OR circuit 66-5 is “1” and the bit value of the output of the exclusive OR circuit 66-6 is “0”, the determination unit 56 determines that an error is not occurring in the bit value of the second bit (the storage data 44-17) stored by the memory unit 52, and determines that an error is being generated in either the storage data 44-7 or the storage data 44-12. Similarly, when the bit value of the output of the exclusive OR circuit 66-5 is “0” and the bit value of the output of the exclusive OR circuit 66-6 is “1”, the determination unit 56 determines that an error is not occurring in the bit value of the second bit (the storage data 44-17) stored by the memory unit 52, and determines that an error is being generated in either the storage data 44-22 or the storage data 44-27.

The correction unit 58 corrects and outputs the bit value of the second bit (the storage data 44-17) stored by the memory unit 52 when the determination unit 56 determines that an error has occurred in the bit value of the second bit (the storage data 44-17) stored by the memory unit 52. In the present example, the correction unit 58 includes an exclusive OR circuit 72-3. The exclusive OR circuit 72-3 is configured to output a logical exclusive disjunction of the bit value of the second bit (the storage data 44-17) stored by the memory unit 52 and the bit value of the output of the AND circuit 68-3 to the output data 46-9. For example, when the determination unit 56 determines that an error is occurring in the bit value of the second bit (the storage data 44-17) stored by the memory unit 52, since the bit value of the output of the AND circuit 68-3 is “1”, the bit value of the second bit (the storage data 44-17) stored by the memory unit 52 is output by being inverted. That is, in a case where the determination unit 56 determines that an error is occurring in the bit value of the second bit (the storage data 44-17) stored by the memory unit 52, “0” is the output to the output data 46-9 when the bit value of the second bit (the storage data 44-17) is “1”, and “1” is output to the output data 46-9 when the bit value of the second bit (the storage data 44-17) is “0”.

When the determination unit 56 determines that an error is not occurring in the bit value of the second bit (the storage data 44-17) stored by the memory unit 52, since the bit value of the output of the AND circuit 68-3 is “0”, the bit value of the second bit (the storage data 44-17) stored by the memory unit 52 is output to the output data 46-9. In FIG. 11, since an error is not occurring in the bit value of the second bit (the storage data 44-17), the bit value of the second bit (the storage data 44-17) is output to the output data 46-9 as it is.

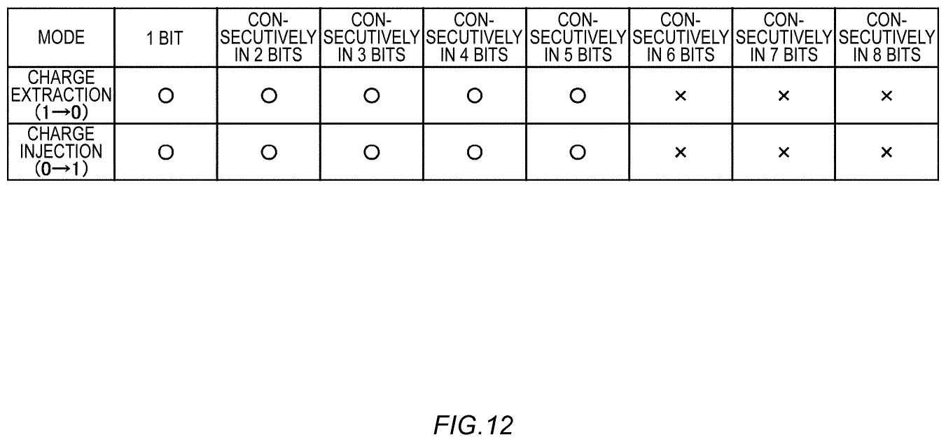

FIG. 12 is a table summarizing whether the compensation can be performed for each of the modes of the processing circuit 20 according to the embodiment of FIG. 11. As described with reference to FIG. 11, to output the output data 46-9, each of the bit values of the storage data 44-7, the storage data 44-12, the storage data 44-17, the storage data 44-22, and the storage data 44-27 is used. Accordingly, since the pieces of the storage data 44 to be used for the correction are not arranged to be adjacent to each other, an error occurring consecutively in up to five bits is correctable in the case of either the charge extraction or the charge injection. In addition, the storage data 44 of FIG. 11 is 32 bits, which is the same as the storage data 22 of the comparative example in FIG. 2. Accordingly, without the increase in the number of EPROMs, the compensation data can be retained even when an error has occurred in the bit value of the data of the single EPROM or the bit values of the data of the plurality of consecutive EPROMs (up to five consecutive EPROMs in the case of FIG. 11).

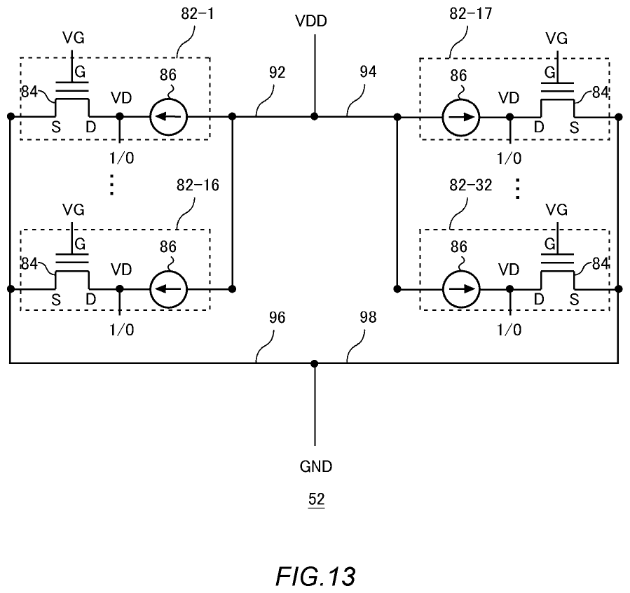

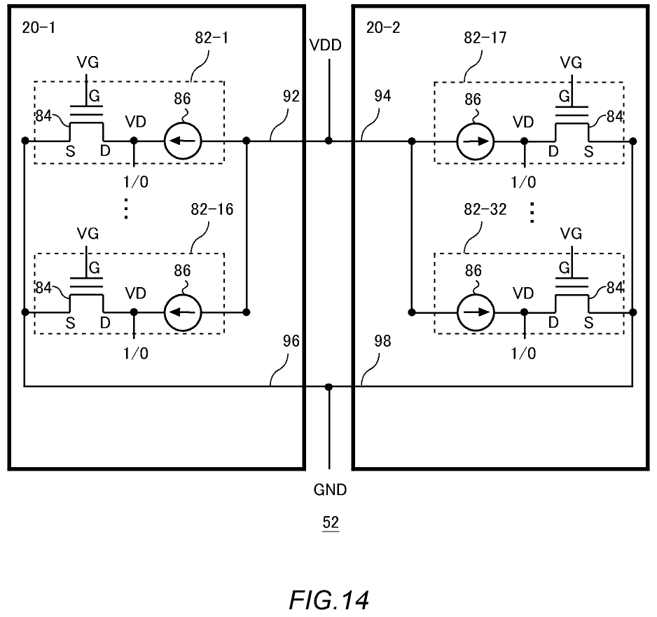

FIG. 13 and FIG. 14 illustrate another example of the wiring of the element 82 included in the memory unit 52. FIG. 13 is different from FIG. 8 in that the high potential line VDD or the reference potential line GND includes a branch wiring. The other configurations of FIG. 13 may be the same as those of FIG. 8.

The high potential line VDD includes a first wiring 92 and a second wiring 94. The first wiring 92 is connected to the elements 82-1 to 82-16. The drain terminal D of the switching element 84 of the elements 82-1 to 82-16 is connected to the first wiring 92 of the high potential line VDD via the constant current source 86. The second wiring 94 is connected to the elements 82-17 to 82-32. The drain terminal D of the switching element 84 of the elements 82-17 to 82-32 is connected to the second wiring 94 of the high potential line VDD via the constant current source 86.

The reference potential line GND includes a first wiring 96 and a second wiring 98. The first wiring 96 is connected to the elements 82-1 to 82-16. The source terminal S of the switching element 84 of the elements 82-1 to 82-16 is connected to the first wiring 96 of the reference potential line GND. The second wiring 98 is connected to the elements 82-17 to 82-32. The source terminal S of the switching element 84 of the elements 82-17 to 82-32 is connected to the second wiring 98 of the reference potential line GND. The elements 82-1 to 82-16 may be provided in parallel in this order between the first wiring 92 of the high potential line VDD and the first wiring 96 of the reference potential line GND. The elements 82-17 to 82-32 may be provided in parallel in this order between the second wiring 94 of the high potential line VDD and the second wiring 98 of the reference potential line GND.

As described above, the element 82 includes a first system of the elements 82-1 to 82-16 and a second system of the elements 82-17 to 82-32. The first system and the second system are connected to the high potential line VDD or the reference potential line GND in a symmetric manner with each other. That is, an electrical path length from a branch point of the high potential line VDD to the elements 82-1 to 82-16 and an electrical path length from the branch point to the elements 82-17 to 82-32 are substantially equal to each other. Similarly, an electrical path length from a branch point of the reference potential line GND to the elements 82-1 to 82-16 and an electrical path length from the branch point to the elements 82-17 to 82-32 are substantially equal to each other. Thus, even when external noise is applied to the high potential line VDD or the reference potential line GND, a tendency of the charge extraction from the floating gate or the charge injection to the floating gate due to the external noise becomes similar between the first system and the second system. For example, the element 82-1 and the element 82-17 are symmetrically arranged with respect to the high potential line VDD and the reference potential line GND. For example, the element 82-16 and the element 82-32 are symmetrically arranged. In this case, there is a chance that the tendency of the charge extraction from the floating gate or the charge injection of the floating gate due to the external noise becomes similar between the symmetrically arranged elements 82. In the above described case, as illustrated in FIG. 14, processing circuits 20-1 and 20-2 can be respectively provided in only the first system of the elements 82-1 to 82-16 and only the second system of the elements 82-17 to 82-32. With this configuration, a calculation by a processing circuit based on a combination of the elements 82-1 and 82-17 with the similar tendency of the charge extraction from the floating gate or the charge injection to the floating gate due to the external noise as described above is not to be performed. Therefore, the retention property of the compensation data against the external noise is improved. Note that the processing circuit 20 illustrated in FIG. 6, FIG. 9, and FIG. 11 can be used for each of the processing circuits 20-1 and 20-2.

While the embodiments of the present invention have been described, the technical scope of the present invention is not limited to the above described embodiments. It is apparent to persons skilled in the art that various alterations and improvements can be added to the above described embodiments. It is also apparent from the scope of the claims that the embodiments added with such alterations or improvements can be included in the technical scope of the present invention.

What is claimed is:

1. A processing circuit for data of multiple bits including a first bit, a second bit, and a third bit, the processing circuit comprising:
a memory unit configured to store a bit value of each bit of the data, a first memory code indicating whether a bit value of the first bit and a bit value of the second bit are identical, and a second memory code indicating whether the bit value of the second bit and a bit value of the third bit are identical;
a code generation unit configured to generate a first generation code indicating whether the bit value of the first bit stored by the memory unit and the bit value of the second bit stored by the memory unit are identical, and a second generation code indicating whether the bit value of the second bit stored by the memory unit and the bit value of the third bit stored by the memory unit are identical; and
a determination unit configured to determine whether, based on a result of a comparison between the first memory code and the first generation code and a result of a comparison between the second memory code and the second generation code, an error has occurred in the bit value of the second bit stored by the memory unit.

2. The processing circuit according to claim 1, further comprising:
a correction unit configured to correct and output the bit value of the second bit stored by the memory unit when the determination unit determines that an error has occurred in the bit value of the second bit stored by the memory unit.

3. The processing circuit according to claim 1, wherein
the determination unit is configured to determine that an error has occurred in the bit value of the second bit stored by the memory unit when the first memory code and the first generation code are different from each other and also when the second memory code and the second generation code are different from each other.

4. The processing circuit according to claim 1, wherein
the determination unit is configured to determine that the bit value of the second bit stored by the memory unit is correct when the first memory code and the first generation code are identical or when the second memory code and the second generation code are identical.

5. The processing circuit according to claim 1, wherein
the determination unit includes
a first exclusive OR circuit configured to output a logical exclusive disjunction of the first memory code and the first generation code,
a second exclusive OR circuit configured to output a logical exclusive disjunction of the second memory code and the second generation code, and
an AND circuit configured to output a logical conjunction of an output of the first exclusive OR circuit and an output of the second exclusive OR circuit.

6. The processing circuit according to claim 1, wherein
the first memory code is a logical exclusive disjunction of the bit value of the first bit and the bit value of the second bit, and
the second memory code is a logical exclusive disjunction of the bit value of the second bit and the bit value of the third bit.

7. The processing circuit according to claim 1, wherein
the first generation code is a logical exclusive disjunction of the bit value of the first bit stored by the memory unit and the bit value of the second bit stored by the memory unit, and
the second generation code is a logical exclusive disjunction of the bit value of the second bit stored by the memory unit and the bit value of the third bit stored by the memory unit.

8. The processing circuit according to claim 1, wherein
the data is compensation data for compensating an output of a pressure sensor.

9. The processing circuit according to claim 1, wherein
the memory unit includes a plurality of elements, respectively configured to store a bit value of each bit of the data, and
the respective elements in the plurality of the elements are provided in parallel between a high potential line and a reference potential line.

10. The processing circuit according to claim 9, wherein
the element configured to store the bit value of the first bit, the element configured to store the bit value of the second bit, and the element configured to store the bit value of the third bit are not arranged to be adjacent to each other.

11. The processing circuit according to claim 9, wherein
the plurality of elements include a plurality of elements respectively configured to store each of memory codes including the first memory code and the second memory code.

12. The processing circuit according to claim 11, wherein
the element configured to store the bit value of the first bit, the element configured to store the bit value of the second bit, the element configured to store the bit value of the third bit, the element configured to store the first memory code, and the element configured to store the second memory code are not arranged to be adjacent to each other.

13. The processing circuit according to claim 9, wherein
the code generation unit is configured to generate the first generation code and the second generation code from a bit value of each bit of the data output from the element.

14. The processing circuit according to claim 9, wherein
the high potential line or the reference potential line includes a branch wiring.

15. The processing circuit according to claim 2, wherein
the determination unit is configured to determine that an error has occurred in the bit value of the second bit stored by the memory unit when the first memory code and the first generation code are different from each other and also when the second memory code and the second generation code are different from each other.

16. The processing circuit according to claim 2, wherein
the determination unit is configured to determine that the bit value of the second bit stored by the memory unit is correct when the first memory code and the first generation code are identical or when the second memory code and the second generation code are identical.

17. The processing circuit according to claim 3, wherein
the determination unit is configured to determine that the bit value of the second bit stored by the memory unit is correct when the first memory code and the first generation code are identical or when the second memory code and the second generation code are identical.

18. The processing circuit according to claim 2, wherein
the determination unit includes
a first exclusive OR circuit configured to output a logical exclusive disjunction of the first memory code and the first generation code,
a second exclusive OR circuit configured to output a logical exclusive disjunction of the second memory code and the second generation code, and
an AND circuit configured to output a logical conjunction of an output of the first exclusive OR circuit and an output of the second exclusive OR circuit.

19. The processing circuit according to claim 3, wherein
the determination unit includes
a first exclusive OR circuit configured to output a logical exclusive disjunction of the first memory code and the first generation code,
a second exclusive OR circuit configured to output a logical exclusive disjunction of the second memory code and the second generation code, and
an AND circuit configured to output a logical conjunction of an output of the first exclusive OR circuit and an output of the second exclusive OR circuit.

20. The processing circuit according to claim 4, wherein
the determination unit includes
a first exclusive OR circuit configured to output a logical exclusive disjunction of the first memory code and the first generation code,
a second exclusive OR circuit configured to output a logical exclusive disjunction of the second memory code and the second generation code, and
an AND circuit configured to output a logical conjunction of an output of the first exclusive OR circuit and an output of the second exclusive OR circuit.
